(19) United States
(12) Patent Application Publication
(10) Pub. No.: US 2015/0181431 A1
(43) Pub. Date: Jun. 25, 2015

(54) Method and Device for Controlling A Data Card APN Locking State, and Data Card

(71) Applicant: ZTE CORPORATION, Shenzhen City , Guangdong Province (CN)

(72) Inventors: Wei Zheng, Shenzhen (CN); Hong Zhang, Shenzhen (CN)

(21) Appl. No.: 14/415,620

(22) PCT Filed: Jul. 24, 2013
(86) PCT No.: PCT/CN2013/079954

§ 371 Date: Jan. 19, 2015

(30) Foreign Application Priority Data
Jul. 24, 2012 (CN) 201210256914.5

(51) Int. Cl. H04W 12/08

(52) U.S. Cl. CPC H04W 12/08

(57) ABSTRACT

A method and apparatus for controlling an APN locking state of a data card, a data card and a method for dialing using the data card. The control method includes: after the data card receives an APN parameter setting instruction which is an administrator user instruction, modifying a current APN locking state of the data card according to a locking state parameter carried in the instruction, and writing an APN parameter carried in the instruction and the APN locking state into a nonvolatile storage area; and the dialing method includes: when a dialing connection is established, PC side dialing software querying the APN locking state of the data card, and if the data card is currently in a locked state, only using an APN parameter set in a default PDP Profile to establish the dialing connection.

### TECHNICAL FIELD

The present document relates to the technology of controlling an Access Point Name (APN) locking state of a data card, and in particular, to a method and apparatus for controlling an APN locking state of a data card, a data card and a method for dialing using the data card.

### BACKGROUND OF THE RELATED ART

With the wide application and gradual popularity of mobile wireless communication technology in the world, mobile terminal products, such as mobile phones, data cards with a variety of interfaces etc., have been gradually transitioned from high-technology pronoun to the general public articles for daily use, even the essentials. Competition among various manufacturers in the market is increasingly fierce, and how to better increase the functions of the products, improve product performance, continuously meet the needs of the user, and enable the terminal products to have better user experience become the hot topic concerned by all major manufacturers.

The APN is a parameter which must be configured by a mobile terminal when the mobile terminal accesses the Internet through a mobile network, and it determines which access manner to use by the mobile terminal to access the network. The APN includes two parts, i.e., a network name and an operator name. The APN is used to identify a specified external internet and a serving Internet Service Provider in a Gateway GPRS Support Node (GGSN), and a GGSN address corresponding to the APN may be parsed according to the APN by a Domain Name System (DNS) in a Serving GPRS Support Node (SGSN). In general, in an operator network, multiple APNs will be set in the GGSN, to provide different types of services and control access permission and range of the external internet. When a user accesses the network, according to an APN in a request transmitted by the user, the SGSN transmits a query request to a DNS server, to find a GGSN connected to a server platform, and performs tunnel encapsulation on the user request and transmit it to the GGSN through a General Data Transfer Platform (GTP); the GGSN transmits user authentication information to Radius through a dedicated line for authentication; after a Radius authentication server confirms that the request is the one transmitted by a legitimate user, the Radius authentication serer requests a Dynamic Host Configuration Protocol (DHCP) server to allocate a user address, and transmits confirmation information carrying the user address to the GGSN; and once obtaining the IP address, the user can normally access the external internet. The APN is generally deployed on a GGSN device or is logically connected to the GGSN, and the user may access the external internet through a GGSN proxy during surfing.

At present, the APN of the data card is usually set by the user when a dialing connection is established, and the APN is not locked. The user terminal can access any network. When different operator networks are accessed for data services, it needs to use APNs provided by different operators. As shown in FIG. 1, the data card includes: an APN parameter processing module and a Packet Data Protocol (PDP) Profile. After the APN parameter processing module receives an APN parameter setting instruction issued by a PC software side, it writes a parsed APN parameter into the PDP Profile, and then PC side software issues a dialing instruction to a dialing module, which uses the PDP Profile which has been set to initiate a PDP activation process.

However, this manner neither can control the network which the user terminal accesses, nor can satisfy demands of some operators and users of enterprise networks for limitation of access permission and range of a terminal network.

### SUMMARY

The technical problem to be solved by the embodiments of the present invention is to provide a method and apparatus for controlling an APN locking state of a data card, a data card and a method for dialing using the data card, which can modify the APN locking state as needed, to control setting permission of the APN parameter when a network is accessed by a user, thereby satisfying different requirements of the user for the access permission and range of a network in different networks and different application scenarios.

In order to solve the above technical problem, the embodiments of the present invention use the following technical schemes:

A method for controlling an Access Point Name (APN) locking state of a data card comprises:
after receiving an APN parameter setting instruction which is an administrator user instruction, the data card modifying a current APN locking state of the data card according to a locking state parameter carried in the APN parameter setting instruction, and writing an APN parameter carried in the APN parameter setting instruction and the APN locking state into a nonvolatile storage area.

Alternatively, the step of modifying the current APN locking state of the data card according to the locking state parameter carried in the APN parameter setting instruction and writing the APN locking state into the nonvolatile storage area comprises:
if the locking state parameter carried in the APN parameter setting instruction is locking, locking the current APN of the data card, and modifying the locking state in the nonvolatile storage area to locked; and
if the locking state parameter carried in the APN parameter setting instruction is unlocking, unlocking the current APN of the data card, and modifying the locking state in the nonvolatile storage area to unlocked.

Alternatively, the method further comprises:
after the data card receives the APN parameter setting instruction, fetching an encryption field carried in the APN parameter setting instruction for checking, and if the checking is successful, writing the APN parameter carried in the APN parameter setting instruction into a default Packet Data Protocol (PDP) Profile, storing the APN parameter into the nonvolatile storage area at the same time, modifying the current APN locking state of the data card according to the locking state parameter carried in the APN parameter setting instruction, and modifying the locking state in the nonvolatile storage area; and if the checking is failed, the data card stopping instruction processing and returning a corresponding error state.

Alternatively, the method further comprises:
after the data card is powered down or upgraded, writing the APN parameter in the nonvolatile storage area into the PDP Profile when the data card is powered on and restarted.

An apparatus for controlling an Access Point Name (APN) locking state of a data card comprises an instruction reception module, an APN locking module, and an APN parameter processing module, wherein,
the instruction reception module is configured to receive an APN parameter setting instruction issued by a PC software side, and when judging that the APN parameter setting instruction is an administrator user instruction, notify the APN parameter setting instruction to the APN locking module and the APN parameter processing module;
the APN locking module is configured to modify a current APN locking state of the data card according to a locking state parameter carried in the APN parameter setting instruction, and write the APN locking state into a nonvolatile storage area; and
the APN parameter processing module is configured to write an APN parameter carried in the APN parameter setting instruction into the nonvolatile storage area.

Alternatively, the APN locking module is configured to modify the current APN locking state of the data card according to the locking state parameter carried in the APN parameter setting instruction and write the APN locking state into the nonvolatile storage area by the following way:
if the locking state parameter carried in the APN parameter setting instruction is locking, locking the current APN of the data card, and modifying the locking state in the nonvolatile storage area to locked; and
if the locking state parameter carried in the APN parameter setting instruction is unlocking, unlocking the current APN of the data card, and modifying the locking state in the nonvolatile storage area to unlocked.

Alternatively, the instruction reception module is further configured to: after receiving the APN parameter setting instruction, fetch an encryption field carried in the APN parameter setting instruction for checking, and if the checking is successful, notify the APN parameter setting to the APN locking module and the APN parameter processing module; and if the checking is failed, stop instruction processing and return a corresponding error state;
the APN locking module is configured to modify the current APN locking state of the data card according to the locking state parameter carried in the APN parameter setting instruction, and modify the locking state in the nonvolatile storage area; and
the APN parameter processing module is configured to write the APN parameter carried in the APN parameter setting instruction into a default Packet Data Protocol (PDP) Profile, and store the APN parameter into the nonvolatile storage area at the same time.

Alternatively, the apparatus further comprises a main control module, wherein:
the main control module is configured to: after the data card is powered down or upgraded, write the APN parameter in the nonvolatile storage area into the PDP Profile when the data card is powered on and restarted.

A data card comprises: the apparatus for controlling an Access Point Name (APN) locking state of a data card as described above and a Packet Data Protocol (PDP) Profile and a nonvolatile storage area connected to the apparatus.

A method for dialing using the data card as described above comprises:
when a dialing connection is established, PC side dialing software querying the APN locking state of the data card, and if the current APN locking state of the data card is a locked state, not allowing to carry an APN parameter in a dialing instruction issued by the PC side dialing software, and only using an APN parameter set in a default PDP Profile to establish the dialing connection.

The above method and apparatus for controlling an APN locking state of a data card, a data card and a method for dialing using the data card control setting permission of the APN parameter when a network is accessed by a user by modifying the APN locking state of the data card of the terminal, so that the user may only use a specific APN parameter to access a specific network in a specific application scenario, thereby satisfying different requirements of the user for the access permission and range of a network in different networks and different application scenarios.

### BRIEF DESCRIPTION OF DRAWINGS

FIG. 1 is a structural diagram of a data card in the related art;

FIG. 2 is a structural diagram of a data card in an embodiment;

FIG. 3 is a flowchart of a method for controlling an APN locking state of a data card in an embodiment;

FIG. 4 is a flowchart of a method for controlling an APN locking state of a data card in an application example;

FIG. 5 is a flowchart of a method for dialing using the data card in FIG. 3 in another application example; and

FIG. 6 is a flowchart of automatically recovering an APN locking state of a data card in another application example.

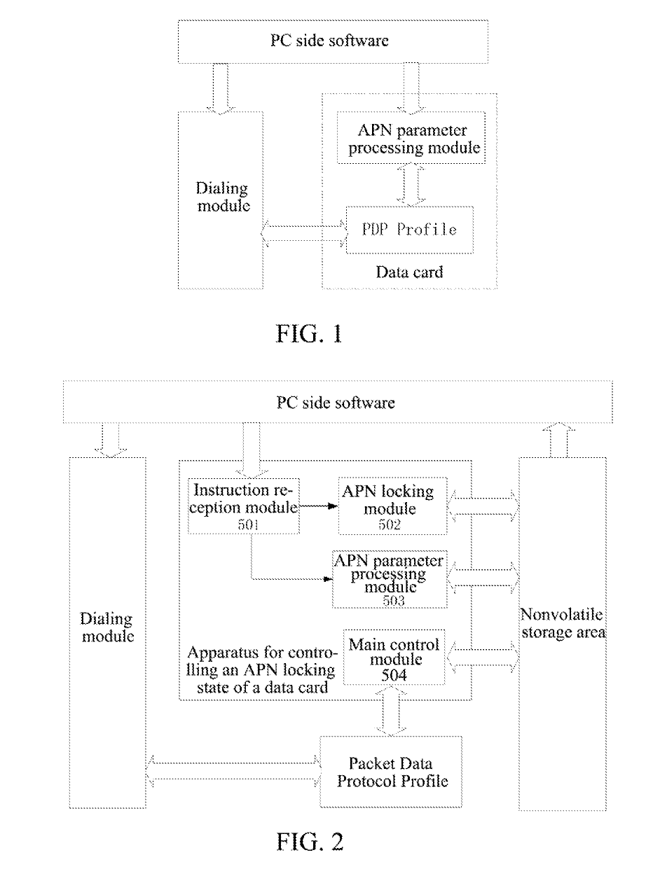

### PREFERRED EMBODIMENTS OF THE PRESENT INVENTION

In order to make the purpose, technical schemes, and advantages of the present document more clear and obvious, the embodiments of the present invention will be described in detail below in conjunction with accompanying drawings. It should be illustrated that without conflict, the embodiments in the present application and the features in the embodiments could be combined with each other randomly.

### Embodiments

As shown in FIG. 2, the present embodiment provides a data card, including an apparatus for controlling an APN locking state of a data card and a PDP Profile and a nonvolatile storage area connected to the apparatus. Wherein, the apparatus for controlling an APN locking state of a data card comprises an instruction reception module 501, an APN locking module 502, an APN parameter processing module 503 and a main control module 504, the main control module 504 is connected to the PDP Profile and the nonvolatile storage area, wherein,
the instruction reception module 501 is configured to receive an APN parameter setting instruction issued by a PC software side, and when judging that the APN parameter setting instruction is an administrator user instruction, notify the APN parameter setting instruction to the APN locking module 502 and the APN parameter processing module 503;
wherein, after the instruction reception module 501 receives the APN parameter setting instruction issued by a PC side software, it firstly judged whether the instruction is currently a common user instruction or an administrator user instruction according to different issued commands. If it is a common user instruction, the issued APN parameter is written into a default PDP Profile and is backed up to a nonvolatile storage area; and if it is an administrator user, the APN parameter setting instruction is notified to the APN locking module and the APN parameter processing module.

Alternatively, the instruction reception module 501 is further configured to after receiving the APN parameter setting instruction, fetch an encryption field carried in the APN parameter setting instruction for checking, and if the checking is successful, notify the APN parameter setting to the APN locking module and the APN parameter processing module; and if the checking is failed, stop instruction processing and return a corresponding error state;
the APN locking module 502 is configured to modify a current APN locking state of the data card according to a locking state parameter carried in the APN parameter setting instruction, and write the APN locking state into a nonvolatile storage area; and
wherein, if the locking state parameter carried in the APN parameter setting instruction is locking, the APN locking module 502 locks the current APN of the data card, and modifies the locking state in the nonvolatile storage area to locked; and
if the locking state parameter carried in the APN parameter setting instruction is unlocking, the APN locking module 502 unlocks the current APN of the data card, and modifies the locking state in the nonvolatile storage area to unlocked.

Wherein, the APN locking module 502 modifying the current APN locking state of the data card is modifying the locking state in the nonvolatile storage area.

The APN parameter processing module 503 is configured to write an APN parameter carried in the APN parameter setting instruction into the nonvolatile storage area.

At the same time, the APN parameter processing module 503 is further configured to write the APN parameter carried in the APN parameter setting instruction into a default PDP Profile.

The main control module 504 is configured to: after the data card is powered down or upgraded, write the APN parameter in the nonvolatile storage area into the PDP Profile when the data card is powered on and restarted.

For example, when the data card is powered on, the main control module 504 will check a default PDP Profile during initialization, and if the default PDP Profile is not created, a default PDP Profile is generated and a stored APN parameter is fetched from the nonvolatile storage area and is written into the default PDP Profile; and if the default PDP Profile has been created, it is checked whether an APN parameter in the PDP Profile is empty, and if so, the stored APN parameter is fetched from the nonvolatile storage area and is written into the default PDP Profile, and thereby the data card may be recovered to a locking state before the power-on and restart.

When dialing is established, PC side dialing software firstly judges a locking state of the data card, and then issues a dialing instruction according to a locking state returned by the apparatus for controlling an APN locking state of a data card of a terminal according to the present embodiment. If the issued dialing instruction carries an APN, the data card will directly use the APN for dialing. If the APN is not carried, the APN set in the default PDP Profile is used for dialing.

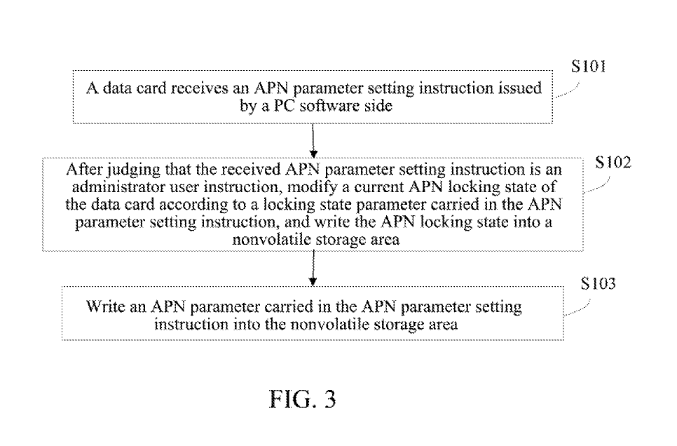

As shown in FIG. 3, the present embodiment provides a method for controlling an APN locking state of a data card, comprising the following steps.

In S101, a data card receives an APN parameter setting instruction issued by a PC software side.

In S102, after judging that the received APN parameter setting instruction is an administrator user instruction, a current APN locking state of the data card is modified according to a locking state parameter carried in the APN parameter setting instruction, and the APN locking state is written into a nonvolatile storage area.

Wherein, if the locking state parameter carried in the APN parameter setting instruction is locking, the current APN of the data card is locked, and the locking state in the nonvolatile storage area is modified to locked; and
if the locking state parameter carried in the APN parameter setting instruction is unlocking, the current APN of the data card is unlocked, and the locking state in the nonvolatile storage area is modified to unlocked.

In S103, an APN parameter carried in the APN parameter setting instruction is written into a nonvolatile storage area.

Step S102 further includes a parameter checking step, in which after the data card receives the APN parameter setting instruction, an encryption field carried in the APN parameter setting instruction is fetched for checking, and if the checking is successful, the current APN locking state of the data card is modified according to the locking state parameter carried in the APN parameter setting instruction, and the locking state in the nonvolatile storage area is modified, and the APN parameter carried in the APN parameter setting instruction is written into a default PDP Profile in step S103; and if the checking is failed, the data card stops instruction processing and returns a corresponding error state.

In step S103, after the APN parameter and the locking state have been set successfully, they will be stored in a nonvolatile storage area. Therefore, after the data card is powered down or upgraded, when the data card is powered on and restarted, the APN locking state of the data card may be automatically recovered according to the APN parameter and the APN locking state stored in the nonvolatile storage area, i.e., the APN parameter in the nonvolatile storage area is written into the PDP Profile, which specifically comprises the following contents.

For example, when the data card is powered on and restarted, it is firstly checked whether a default PDP Profile has been created, and if the default PDP Profile is not created, a PDP Profile is automatically generated and the APN parameter in the nonvolatile storage area is written into the default PDP Profile; and if the default PDP Profile has been created, it is checked whether the APN parameter in the PDP Profile is empty, and if so, the APN parameter in the nonvolatile storage area is written into the PDP Profile, and thereby the data card may be recovered to a locking state before the power-on and restart.

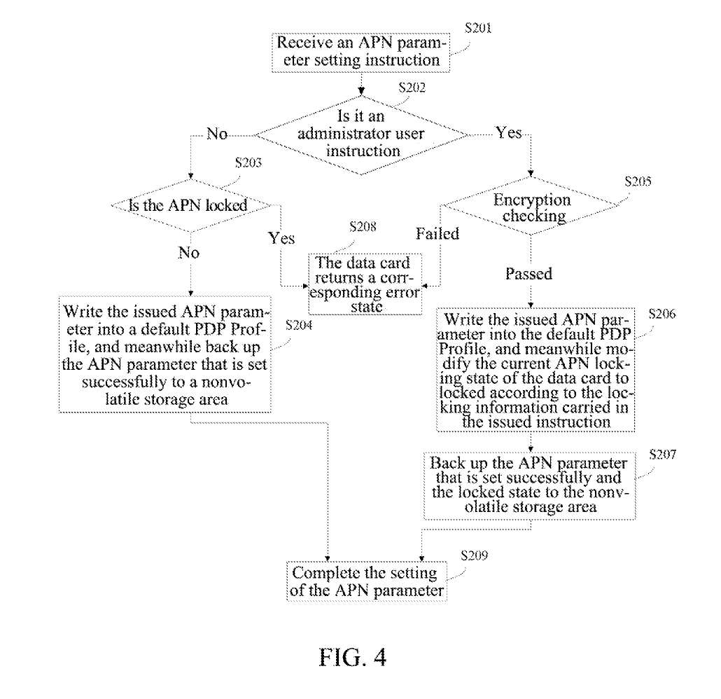

In an application example, as shown in FIG. 4, a method for controlling an APN locking state of a data card includes the following steps.

In S201, the data card receives an issued APN parameter setting instruction;
in S202, the data card judges a type of the current APN parameter setting instruction, and if the current issued APN parameter setting instruction is a common user instruction, step S203 will be performed; and if the current issued APN parameter setting instruction is an administrator user instruction, step S203 will be performed;
in S203, the data card firstly judges a current APN locking state, and if the current APN is in a locked state, the APN parameter is set unsuccessfully, and step S208 will be performed; and if the current APN is in an unlocked state, step S204 will be performed;
in S204, the issued APN parameter is written into a default PDP Profile, and the APN parameter which is set successfully is backed up to a nonvolatile storage area at the same time;
in S205, encryption checking is performed, and if the checking is successful, step S206 will be performed; and if the checking is failed, the processing procedure will be stopped, and step S208 will be performed;
in S206, the issued APN parameter is written into the default PDP Profile, and the current APN locking state of the data card is modified to locked according to the locking information carried in the issued instruction;
in S207, the APN parameter which is set successfully and the locked state are backed up to the nonvolatile storage area;
in S209, the APN parameter is set completely;
in S208, the data card returns a corresponding error state.

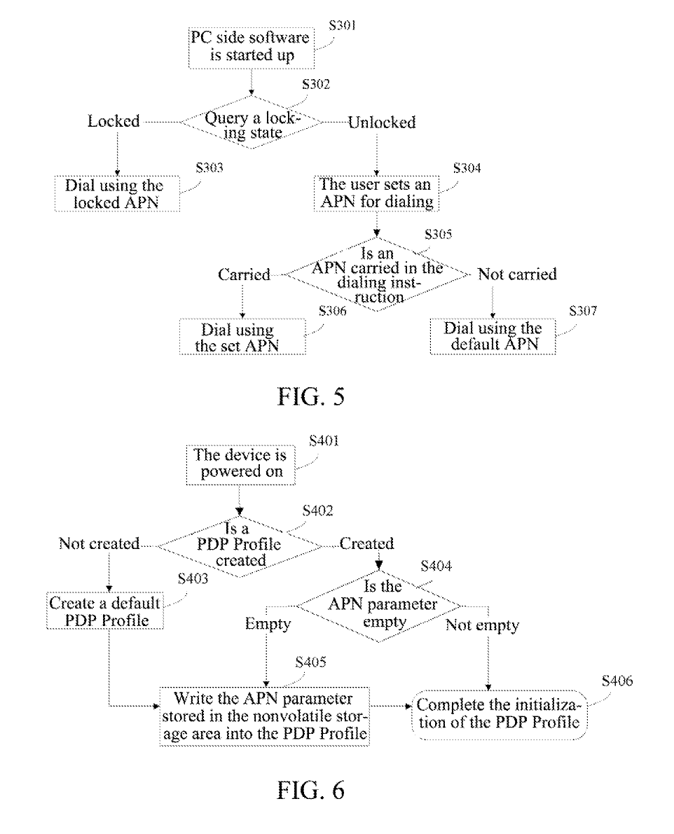

In another application example, as shown in FIG. 5, a method for dialing using the above data card in FIG. 3 includes the following steps.

In S301, when a dialing connection is established by a user, PC side dialing software will be firstly started up;
in S302, after the dialing software is started up, an instruction is issued for querying an APN locking state of the data card; and if a query result is a locked state, step S303 will be performed; and if the query result is an unlocked state, step S304 will be performed;
in S303, the dialing software does not allow the user to set an APN parameter for the dialing, and only the locked APN parameter reported by the data card to the dialing software can be used for establishing a dialing connection;
in S304, the dialing software allows the user to set an APN parameter for the dialing, and the parameter will be carried in the dialing instruction to be transmitted to the data card;
in S305, after receiving the dialing instruction, the data card judges whether there is an APN parameter carried; if so, step S306 will be performed; and if not, step S307 will be performed;
in S306, the APN parameter will be used directly for establishing a dialing connection;
in S307, the APN parameter in the default PDP Profile is used for establishing a dialing connection.

In another application example, when the data card is powered on and restarted, the APN locking state of the data card may be automatically recovered according to the APN parameter and the APN locking state stored in the nonvolatile storage area, as shown in FIG. 6, which comprises the following steps.
in S401, the device is powered on and restarted;
in S402, a main control module checks whether a default PDP Profile has been created; and if not, step S403 will be performed; and if so, step S404 will be performed;
in S403, a default PDP Profile is created, and the procedure turns to step S405;
in S404, it is checked whether the APN parameter in the PDP Profile is empty; and if the APN parameter in the default PDP Profile is empty, step S405 will be performed; otherwise, step S406 will be performed;
in S405, the APN parameter stored in the nonvolatile storage area is written into the PDP Profile;

In S406, the processing procedure ends, and the initialization of the PDP Profile is completed.

It can be seen from the above embodiments that compared with the related art, the method and apparatus for controlling an APN locking state of a data card, the data card and the method for dialing using the data card provided in the above embodiments control the used APN when establishing a network connection to control the range of the core network and external Internet which are accessed by the terminal by modifying the APN locking state of the data card of the terminal, so that the user can only use a specific APN parameter to access a specific network in a specific application scenario, thereby satisfying different requirements of the user for the access permission and range of a network in different networks and different application scenarios. For example, an operator desires that a terminal can only be used under its network, or the terminal accesses its core network in a roaming manner under other networks. Therefore, the APN of the data card of the terminal can be locked. Thus, the terminal is determined to access a corresponding GGSN after establishing a connection, thereby controlling a network path from the terminal to the external Internet. Similarly, for an enterprise user, it only desires an employee to access its own enterprise network, and cannot access other Internet. Thus, the range to access the network can also be controlled by locking the APN. In addition, the locked state and the unlocked state of the APN may be changed dynamically as needed. When the data card of the terminal is in a locked state, the user can only access networks in the limited range, and when the APN of the data card of the terminal is in an unlocked state, there is no limitation on the network which is accessible by the terminal, and the user may access any network randomly.

A person having ordinary skill in the art can understand that all or a part of steps in the above method can be implemented by programs instructing related hardware, and the programs can be stored in a computer readable storage medium, such as a read-only memory, disk or disc etc. Alternatively, all or a part of steps in the above embodiments can also be implemented by one or more integrated circuits. Accordingly, each module/unit in the above embodiments can be implemented in a form of hardware, or can also be implemented in a form of software functional module. The present document is not limited to any particular form of a combination of hardware and software.

The above description is only the optional embodiments of the present invention and it is not intended to limit the protection scope of the present document. According to the inventive contents of the present document, there may be many other embodiments. Those skilled in the related art can make various corresponding modifications and variations according to the present document, without departing from the spirit and essence thereof of the present document. Any modification, equivalent substitution and improvement made within the spirit and principle of the present document should be included within the protection scope of the present document.

### INDUSTRIAL APPLICABILITY

The above method and apparatus for controlling an APN locking state of a data card, a data card and a method for dialing using the data card control setting permission of the APN parameter when a network is accessed by a user by modifying the APN locking state of the data card of the terminal, so that the user may only use a specific APN parameter to access a specific network in a specific application scenario, thereby satisfying different requirements of the user for the access permission and range of a network in different networks and different application scenarios. Therefore, the present document has a strong industrial applicability.

What is claimed is:

1. A method for controlling an Access Point Name (APN) locking state of a data card, comprising:
after receiving an APN parameter setting instruction which is an administrator user instruction, the data card modifying a current APN locking state of the data card according to a locking state parameter carried in the APN parameter setting instruction, and writing an APN parameter carried in the APN parameter setting instruction and the APN locking state into a nonvolatile storage area.

2. The method according to claim 1, wherein, the step of modifying the current APN locking state of the data card according to the locking state parameter carried in the APN parameter setting instruction and writing the APN locking state into the nonvolatile storage area comprises:
if the locking state parameter carried in the APN parameter setting instruction is locking, locking the current APN of the data card, and modifying the locking state in the nonvolatile storage area to locked; and
if the locking state parameter carried in the APN parameter setting instruction is unlocking, unlocking the current APN of the data card, and modifying the locking state in the nonvolatile storage area to unlocked.

3. The method according to claim 2, further comprising:
after receiving the APN parameter setting instruction, the data card fetching an encryption field carried in the APN parameter setting instruction for checking, and if the checking is successful, writing the APN parameter carried in the APN parameter setting instruction into a default Packet Data Protocol (PDP) Profile, storing the APN parameter into the nonvolatile storage area at the same time, modifying the current APN locking state of the data card according to the locking state parameter carried in the APN parameter setting instruction, and modifying the locking state in the nonvolatile storage area; and if the checking is failed, the data card stopping instruction processing and returning a corresponding error state.

4. The method according to claim 3, further comprising:
after being powered down or upgraded, the data card writing the APN parameter in the nonvolatile storage area into the PDP Profile when the data card is powered on and restarted.

5. An apparatus for controlling an Access Point Name (APN) locking state of a data card, comprising an instruction reception module, an APN locking module, and an APN parameter processing module, wherein,
the instruction reception module is configured to receive an APN parameter setting instruction issued by a PC software side, and when judging that the APN parameter setting instruction is an administrator user instruction, notify the APN parameter setting instruction to the APN locking module and the APN parameter processing module;
the APN locking module is configured to modify a current APN locking state of the data card according to a locking state parameter carried in the APN parameter setting instruction, and write the APN locking state into a nonvolatile storage area; and
the APN parameter processing module is configured to write an APN parameter carried in the APN parameter setting instruction into the nonvolatile storage area.

6. The apparatus according to claim 5, wherein, the APN locking module is configured to modify the current APN locking state of the data card according to the locking state parameter carried in the APN parameter setting instruction and write the APN locking state into the nonvolatile storage area by the following way:
if the locking state parameter carried in the APN parameter setting instruction is locking, locking the current APN of the data card, and modifying the locking state in the nonvolatile storage area to locked; and
if the locking state parameter carried in the APN parameter setting instruction is unlocking, unlocking the current APN of the data card, and modifying the locking state in the nonvolatile storage area to unlocked.

7. The apparatus according to claim 6, wherein,
the instruction reception module is further configured to: after receiving the APN parameter setting instruction, fetch an encryption field carried in the APN parameter setting instruction for checking, and if the checking is successful, notify the APN parameter setting to the APN locking module and the APN parameter processing module; and if the checking is failed, stop instruction processing and return a corresponding error state;
the APN locking module is configured to modify the current APN locking state of the data card according to the locking state parameter carried in the APN parameter setting instruction, and modify the locking state in the nonvolatile storage area; and
the APN parameter processing module is configured to write the APN parameter carried in the APN parameter setting instruction into a default Packet Data Protocol (PDP) Profile, and store the APN parameter into the nonvolatile storage area at the same time.

8. The apparatus according to claim 7, wherein the apparatus further comprises a main control module, wherein:
the main control module is configured to: after the data card is powered down or upgraded, write the APN parameter in the nonvolatile storage area into the PDP Profile when the data card is powered on and restarted.

9. A data card, comprising: the apparatus for controlling an Access Point Name (APN) locking state of a data card according to claim 5 and a Packet Data Protocol (PDP) Profile and a nonvolatile storage area connected to the apparatus.

10. A method for dialing using the data card according to claim 9, comprising:
when a dialing connection is established, PC side dialing software querying the APN locking state of the data card, and if the current APN locking state of the data card is a locked state, not allowing to carry an APN parameter in a dialing instruction issued by the PC side dialing software, and only using an APN parameter set in a default PDP Profile to establish the dialing connection.

11. The data card according to claim 9, wherein, the APN locking module in the apparatus is configured to modify the current APN locking state of the data card according to the locking state parameter carried in the APN parameter setting instruction and write the APN locking state into the nonvolatile storage area by the following way:
if the locking state parameter carried in the APN parameter setting instruction is locking, locking the current APN of the data card, and modifying the locking state in the nonvolatile storage area to locked; and
if the locking state parameter carried in the APN parameter setting instruction is unlocking, unlocking the current APN of the data card, and modifying the locking state in the nonvolatile storage area to unlocked.

12. The data card according to claim 11, wherein, in the apparatus,
the instruction reception module is further configured to: after receiving the APN parameter setting instruction, fetch an encryption field carried in the APN parameter setting instruction for checking, and if the checking is successful, notify the APN parameter setting to the APN locking module and the APN parameter processing module; and if the checking is failed, stop instruction processing and return a corresponding error state;
the APN locking module is configured to modify the current APN locking state of the data card according to the locking state parameter carried in the APN parameter setting instruction, and modify the locking state in the nonvolatile storage area; and
the APN parameter processing module is configured to write the APN parameter carried in the APN parameter setting instruction into a default Packet Data Protocol (PDP) Profile, and store the APN parameter into the nonvolatile storage area at the same time.

13. The data card according to claim 12, wherein the apparatus further comprises a main control module, wherein:
the main control module is configured to: after the data card is powered down or upgraded, write the APN parameter in the nonvolatile storage area into the PDP Profile when the data card is powered on and restarted.
